(19) United States
(12) Patent Application Publication
(10) Pub. No.: US 2026/0211821 A1
(43) Pub. Date: Jul. 23, 2026

(54) METHOD FOR MINIMALLY INVASIVE SYNCHRONIZED MEDIA INTERCONNECT TESTING

(71) Applicant: INTERNATIONAL BUSINESS MACHINES CORPORATION, Armonk, NY (US)

(72) Inventors: Jeffrey Bisti, New Paltz, NY (US); Philip Siconolfi, Massapequa, NY (US); Robert Paquin, Poughkeepsie, NY (US)

(21) Appl. No.: 19/034,126

(22) Filed: Jan. 22, 2025

(51) Int. Cl. G06F 13/10

(52) U.S. Cl. CPC G06F 13/10; G06F 2213/40

(57) ABSTRACT

A method, system, and computer product for testing media interconnects are described herein. A response from a plurality of devices is requested. An identification is requested from at least a subset of the plurality of devices. At least one link is established within the subset of devices. The at least one link defines a connection between a pair of devices in the subset. A diagnostic test of one or more linked devices connected by the at least one link is initiated. Available device sensors of the one or more linked devices are read. Based on the available device sensors, it is determined whether the diagnostic test can be performed without interrupting operation of the one or more linked devices.

### BACKGROUND

Embodiments of the present disclosure relate to testing media interconnects.

### BRIEF SUMMARY

According to embodiments of the present disclosure, a method for testing media interconnects is provided. A response from a plurality of devices is requested via a network. Identification from a subset of the plurality of devices is requested via the network. At least one link is established within the subset of devices. The at least one link defines a connection (e.g., a direct connection) between a pair of devices in the subset. A diagnostic test of one or more linked devices connected by the at least one link is initiated. Available device sensors of the one or more linked devices are read. Based on the available device sensors, it is determined whether the diagnostic test can be performed without interrupting operation of the one or more linked devices.

Each of the plurality of devices may be interconnected via a wireless network. Configuration data of a first device may be read. The configuration data may include specifications and requirements of the first device. The configuration data may include an identification of the first device. Requesting identification from the at least the subset of the plurality of devices may be based on the configuration data. The first device may be directly connected to at least one of the devices in the plurality. The plurality of devices may include a microphone, a preamplifier, a mixer, a recorder, and/or an outboard effects unit. At least one chain may be established, with each chain including at least two links. The diagnostic test may be run such that one or more links in the at least one chain are tested synchronously. The at least two links may include a first link between a first device and a second device and a second link between the second device and a third device. Each of the links within a chain may be reconfigured for the diagnostic test. Reconfiguring each of the links within the chain for the diagnostic test may include changing a port. A status may be sent to a hub device. The hub device may include a digital audio workstation. Determining whether the diagnostic test can be performed without interrupting operation of the one or more linked devices may include comparing a probability of interruption to a threshold based on configuration data. The one or more linked devices may be queried. The eligibility of the one or more linked devices for the diagnostic test may be determined. Based on the diagnostic test, a signal may be transmitted to an indicator of one of the linked devices. It may be detected that no hub device is established. It may be determined that one of the plurality of devices is capable of serving as the hub device. A message that the one of the plurality of devices is capable of serving as the hub device is broadcasted. It may be determined that one of the plurality of devices is a stand-alone device. A status that the one of the plurality of devices is a stand-alone device is stored. The status may be sent to the hub device when the hub device is established.

According to embodiments of the present disclosure, systems for testing media interconnects are provided. A system comprising a computing node is provided. The computing node comprises a computer readable storage medium having program instructions embedded therewith. The program instructions are executable by a processor of the computing node to cause the processor to perform a method for testing media interconnects as disclosed herein.

According to embodiments of the present disclosure, computer products for testing media interconnects are provided. One or more computer-readable storage media are provided. Program instructions are stored on the one or more computer-readable storage media to perform operations including operations of a method for testing media interconnects as disclosed herein.

### BRIEF DESCRIPTION OF THE SEVERAL VIEWS OF THE DRAWINGS

FIG. 1 is a logical flow diagram illustrating a process for establishing links between compatible devices, in accordance with one or more embodiments of this disclosure.

FIG. 2 is a block layout illustrating devices and the logical connections between devices, in accordance with one or more embodiments of this disclosure.

FIG. 3 is a logical flow diagram illustrating a process for testing linked devices, in accordance with one or more embodiments of this disclosure.

FIG. 4 is a flowchart illustrating a method for testing media interconnects, in accordance with one or more embodiments of this disclosure.

FIG. 5 depicts a computing node, in accordance with one or more embodiments of this disclosure.

FIG. 6 depicts a computing environment for the execution of at least some of the computer code involved in performing a method for testing media interconnects, in accordance with one or more embodiments of this disclosure.

### DETAILED DESCRIPTION

In multimedia production, testing analog cables is a task that can be labor-intensive and interruptive to devices. Testing cables is often only performed when a problem is already identified through other means (e.g., signal degradation or loss, physical inspection, device malfunction). Tools such as test cards, patterns, and “test 1-2-3” sequences can identify obvious issues once they are suspected, however, they often cannot detect more subtle signs of near-failure and potentially destructive conditions.

Dedicated cable testing devices are commonly used in multimedia production environments, with wireless cable testers available to expedite testing of longer, end-to-end cable runs. In the field of networking, individual ports can be reconfigured into a testing mode to emulate a cable tester, facilitating the verification of links between switches. However, these devices and methods do not address the need for diagnostic testing after setting up devices, nor do they minimize service disruptions during testing activities. A cable tested with a basic cable tester may pass a basic continuity test but contain individual pins with short circuits. For example, in a cable with 20 pins on each end, even if the cable passes a signal test, a short between pin #3 and pin #18 would indicate a fault, requiring the cable to be replaced.

Dedicated cable testing is particularly important in applications where high-voltage signals are transmitted through cables, and isolation from other circuits must be maintained. For example, many microphones and devices rely on 48 V “Phantom Power” to operate. If the wire carrying the current is shorted out against another wire, it can damage connected devices.

The present disclosure is directed to a method that utilizes embedded devices and sensors to establish a series of signal paths within a network or production environment, allowing for synchronous testing of multiple signal paths. Once the topology of the environment has been mapped, periodic testing can be conducted in a way that minimizes the chance of disruption to ongoing operations. Data from tests can be stored and displayed at a single location, allowing for real-time monitoring of cable and signal integrity across interconnected devices. In this way, there is proactive maintenance of the devices while minimizing downtime and service interruptions during the testing process.

To facilitate efficient testing and monitoring of signal integrity, the method utilizes addressable circuity capable of performing end-to-end cable tests within each device. When necessary, the devices can form a mesh network, using an initialization period to establish linkages and determine the direction of the signal where applicable. Signal paths can be managed via software, allowing for the assignment of device names, positioning, and the configuration of testing policies.

Connections running end-to-end can leverage the host system to detect the presence or imminent presence of a signal, enabling scheduling and performing automatic tests at optimal times. This can ensure minimal disruption to ongoing operations, as tests are conducted when conditions permit. In this way, a recording or broadcast engineer has early knowledge of any potential connection issues, allowing them to address problems before they escalate to a point where they negatively impact the quality of the signal. This early detection can help maintain signal health and reliability, which can ultimately reduce the risk of operational failures or quality degradation during tasks.

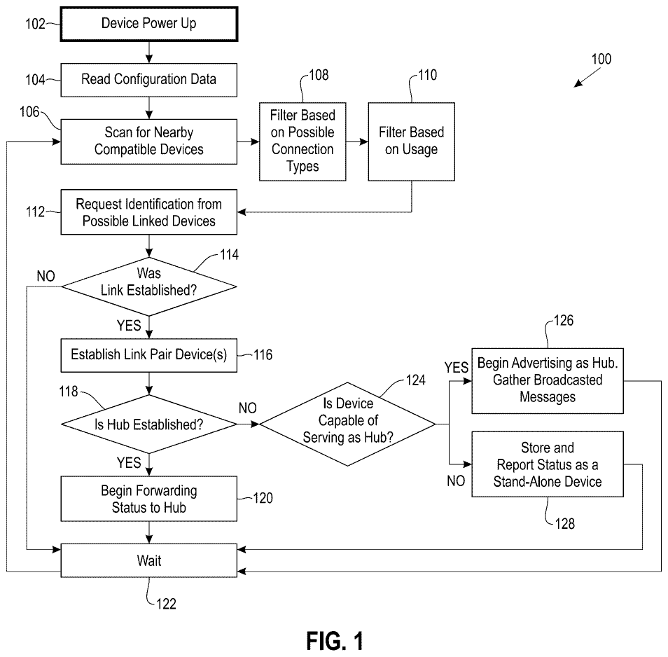

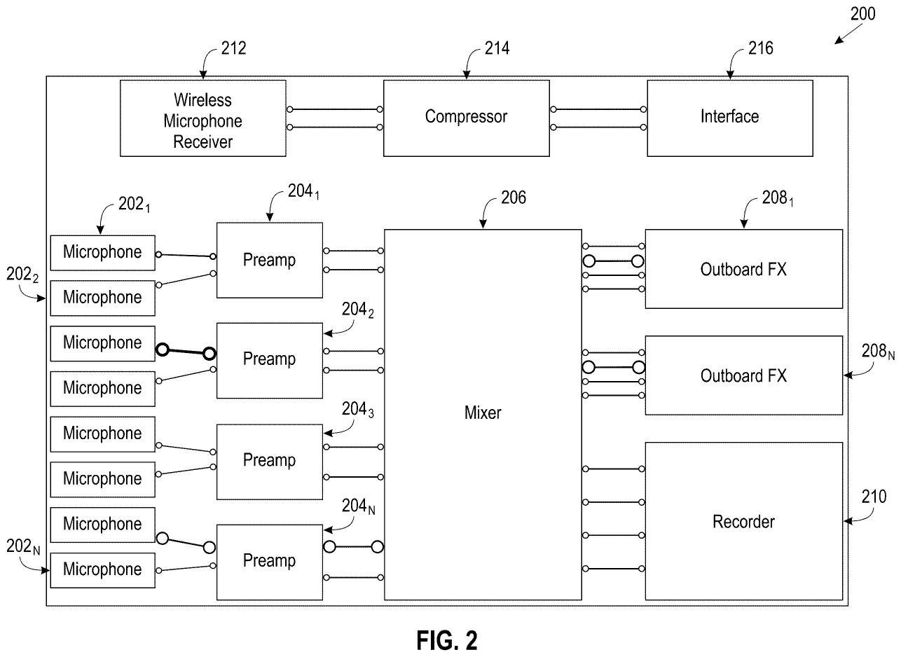

Referring now to FIG. 1, a logical flow diagram 100 illustrating a process for establishing links between compatible devices is shown. In a multimedia production environment, multiple devices can be connected by direct connection (e.g., cable connection) and/or indirect connection (e.g., wireless connection). An indirect connection can also include a connection where a first device is connected to a second device via an intermediate device directly connected to the first device and the second device. A device can include a microphone, a preamplifier, a mixer, a recorder, a camera, and/or an outboard effects unit. For example, FIG. 2 is a block layout 200 illustrating devices and the logical connections between devices in a multimedia production environment. One or more microphones 202 (microphone 202₁, 202₂, and 202_{N,} hereinafter collectively referred to as microphones 202) may each be connected to a preamplifier 204 (preamplifier 204₁, 204₂, 204₃, and 204_{N,} hereinafter collectively referred to as preamplifiers 204). Multiple microphones 202 may be connected to a preamplifier 204. For example, in FIG. 2, the microphones 202₁, 202₂ are connected to the preamplifier 204₁. One or more preamplifiers 204 may be connected to a mixer 206. The mixer 206 may be connected to one or more outboard effects units 208 (outboard effects units 208₁, 208_{N}, herein after collectively referred to as outboard effects units 208). The mixer 206 may be connected to a recorder 210. The multimedia production environment may include a wireless microphone receiver 212, which is connected to a compressor 214, and the compressor may be connected to an interface 216.

At 102, a first device (e.g., microphone, camera, smart device) is plugged into a second device and turned on. The first device may be plugged into the second device using a cable. The first and second device may be part of a plurality of devices that are interconnected via a wireless network. At least some devices of the plurality (i.e., at least a subset of the plurality of devices) may be connected to each other directly (e.g., via cables). The first device may send out a wireless signal to the network. At 104, configuration data is read. The configuration data may include an identifier of the first device which can include device specifications and requirements (e.g., device type, compatible connection types, etc.).

At 106, compatible devices near the first device are scanned. A response from nearby devices may be requested. This communication may be facilitated over Wi-Fi, Bluetooth, and/or other near-field communication methods. The first device may send out an electrical signal (e.g., a pulse width modulation signal) on its physical connectivity to identify devices that the first device is directly plugged into and/or indirectly plugged into. Nearby devices that are not actively in use may respond with their unique identifier and an encoded message along the end-to-end signal path. This can be done to identify overall end-to-end signal paths; however, this may not identify the exact placement of the link within the signal path. The signal may be cascaded to isolate which device(s) the first device is directly plugged into. For example, the first device may be directly connected to a second device and indirectly connected to a third device which is directly connected to the second device. In this way, the topology of the devices is mapped out by detecting the device(s) present in the network and determining how they are connected to each other. This process may be repeated with each device added to the environment.

The configuration data of the first device may be used to determine which devices may be potentially connected to the first device. At 108, the compatible devices may be filtered based on possible connection types (e.g., connection types between the first device and another device directly connected to the first device). Additionally or alternatively, at 110, the compatible devices may be filtered based on usage (e.g., role of the device). The filtering may provide a group or list of one or more devices that are potentially linked (e.g., directly connected) to the first device. At 112, an identification is requested from each potentially linked device. At 116, one or more links is established between the first device and another device. In this way, the devices are paired, the link defines the logical or physical connection between a pair of devices as part of mapping the device topology (e.g., through a handshake process or communication channel setup). Two or more links can form a signal chain. Multiple chains may be established. Scanning of nearby devices may be repeated (e.g., automatically) when a link is not established within a specified period of time. At 120, a status is forwarded to an established hub device (e.g., digital audio workstation). At 122, there may be a wait period if a link is not established and/or there may be a wait period after forwarding the status to the established hub device. At 124, if a hub device is not established, it may be determined that one of the plurality of devices is capable of serving as the hub device. At 126, a message that the one of the plurality of devices is capable of serving as the hub device may be broadcasted. At 124, if a hub device is not established, it may be determined that one of the plurality of devices is a stand-alone device. At 128, a status that the one of the plurality of devices is a stand-alone device may be stored and/or reported. The status may be sent to the hub device when the hub device is established.

One or more tests may be requested after mapping out the connections between the devices. One or more tests may be scheduled to occur periodically. For example, a policy may be set up to run a test every 90 minutes or every 24 hours. In another example, a policy may be set up to prevent testing when a track is armed (i.e., when a recording device is in a condition where it is ready to record). A test may be performed when it is determined that the test will not disrupt operation of the devices (e.g., broadcasting, recording). Multiple signal chains may be tested synchronously. Multiple links may be tested synchronously. For example, if a test is requested for a first link, it may be determined that testing of the first link will disrupt one or more other links, therefore, an additional test(s) may be scheduled for the one or more other links. The one or more other links may be links in the same signal chain as the first link. In this way, the testing of different links can be serialized to minimize disruption of device operation. The links within a signal chain can coordinate a reconfiguration to testing mode, which may involve engaging relays or other means of changing over the device port for diagnostic purposes.

Testing methods can be selected from a library of testing methods which are suitable for different connection types and applications. For multi-use interfaces (e.g., mixers with XLR/TRS/TS jacks), either device or both devices associated with a link may respond with the link type. Additionally or alternatively, the management software may specify the test type. For example, the management software may specify that the test is a 2-conductor test when 3 conductors are available. The results from a test are compared at both ends of the link and connections are restored. The links within a signal chain can coordinate a reconfiguration to operating mode. The status of a test can be stored and/or reported depending on the capabilities and settings of the application. For example, the status of a test may be displayed on the digital audio workstation as a pop-up alert. In another example, the status of a test may be displayed by an indicator (e.g., visual and/or audible indicator) of a stand-alone device. The indicator on the device can include a light indicator capable of signaling a status.

In audio and video application, there a step between “idle” and “recording” referred to as “armed.” In the armed state, the hardware and software are prepared to being a recording session and there are no major background processes running, the caches are available, and sufficient bandwidth is available. By avoiding the recording and armed stated when testing, as well as leveraging usage information and scheduling requests, media interconnects can be monitored more effectively while minimizing downtime.

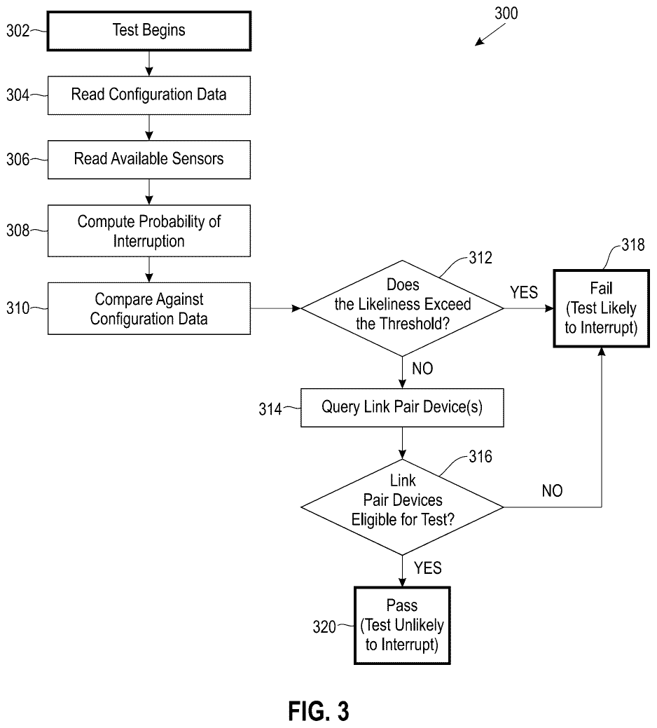

Referring now to FIG. 3, a logical flow diagram 300 illustrating a process for testing linked devices is shown. At 302, a test is initiated. Initiating a test may involve a process of verifying that the test can be performed without interruption to device operation. At 304, configuration data is read. The configuration data may include specifications and requirements of the device(s) to be tested. At 306, available sensors are read. The sensors of the device(s) to be tested are read to determine which sensors are active, will be imminently active, and/or are inactive. At 308, a probability of interruption is computed. The probability of interruption can be based on the available sensors of the device(s). At 310, the probability of interruption is compared against a threshold determined from the configuration data. At 312, it may be determined whether the likelihood of interruption exceeds the threshold. At 314, linked devices are queried if the likelihood of interruption does not exceed the threshold. The queried linked devices can include one or more devices associated with one or more links in a chain. At 316, it is determined whether the linked devices are eligible (e.g., idle, not in use) for the test. For example, linked devices may not be eligible for the test if the track is armed. In another example, linked devices may not be eligible for a test if they are actively being used (e.g., broadcasting, recording). At 318, a failure status is determined and the test is not performed if the device(s) are not eligible for the test or if the likelihood of interruption exceeds the threshold. At 320, a pass status is determined and the test is performed if the device(s) are eligible for the test.

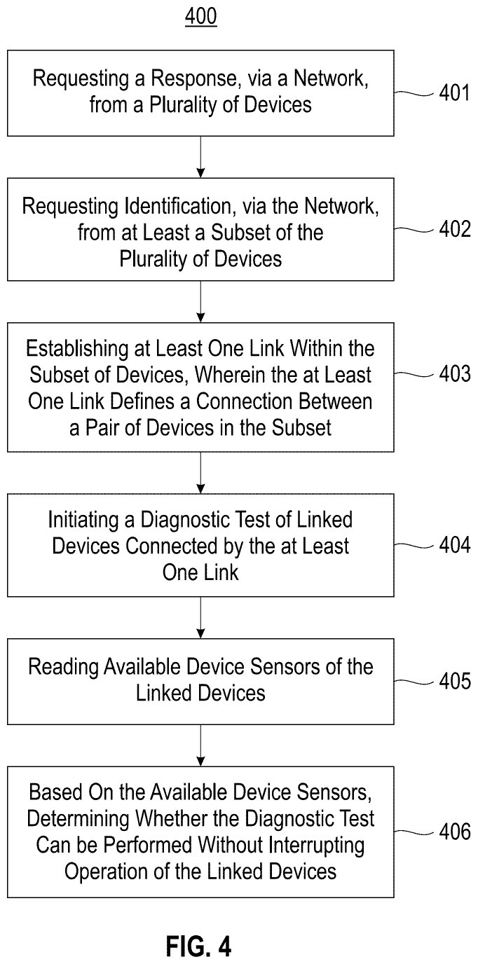

Referring now to FIG. 4, a flowchart illustrating an exemplary method 400 for testing media interconnects is shown. The operations of method 400 presented below are intended to be illustrative. In some implementations, method 400 may be accomplished with one or more additional operation not described and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 400.

Operation 401 may include requesting a response from a plurality of devices via a network. The response may be requested when a first device is plugged into one or more devices. The plurality of devices can include one or more microphones, one or more preamplifiers, one or more mixers, one or more recorders, one or more cameras, and/or one or more outboard effects units. For example, the first device may be a microphone. The plurality of devices may include other devices (e.g., audio devices, imaging device, etc.). The plurality of devices may be interconnected via wireless network.

Operation 402 may include requesting identification from at least a subset of the plurality of devices in the plurality via the network. Requesting identification from at least the subset of the plurality of devices may be based on configuration data of the first device. The configuration data may include specifications, requirements, and an identifier of the first device.

Operation 403 may include establishing at least one link between the subset of devices. The at least one link defines a connection between a pair of devices in the subset. For example, a first link may be established between the first device and a second device. A link defines a connection (e.g., a direct connection) between a pair of devices. At least one signal chain may be established, with each signal chain including at least two links. For example, a first chain can include two links with the first link between the first device and a second device that are directly connected to each other and a second link between the second device and a third device that is directly connected to the second device. In this way, the signal chain defines a sequential path of interconnected devices (e.g., input device(s), processing device(s), amplifying device(s), output device(s)) through which an electrical signal can travel. Each link in the chain represents a connection between a pair of devices that allows for signal transfer.

A status may be sent to a hub device (e.g., digital audio workstation). It may be determined that a hub device is not established. It may be determined that one of the plurality of devices is capable of serving as the hub device. A message may be broadcasted that one of the plurality of devices is capable of serving as the hub device. It may be determined that one of the plurality of devices is a stand-alone device. A status may be stored that one of the plurality of devices is a stand-alone device. The status may be reported by the hub device when the hub is established.

Operation 404 may include initiating a diagnostic test of one or more linked devices connected by the at least one link. For example, a single link may be tested. In another example, a single chain may be tested. The diagnostic test may be initiated by a user or may be initiated automatically. For example, the diagnostic test may be scheduled. Operation 405 may include reading available device sensors of the one or more linked devices. Operation 406 may include determining whether the diagnostic test can be performed without interrupting operation of the one or more linked devices based on the available device sensors. For example, operation of the one or more linked devices may be interrupted if the devices are actively in use or about to be used (e.g., when a track is armed or during recording and/or broadcasting). Operation 406 may include comparing a probability of interrupt to a threshold based on configuration data of a linked device. If it is determined that the diagnostic test can be performed, the linked devices are queried and their eligibility for testing is determined. The test may be performed if the linked devices are eligible for testing. The test may not be performed if the linked devices are not eligible for testing.

It may be determined that the test interrupts other links apart from the link being tested. Other links may be automatically included in the diagnostic test. For example, if a diagnostic test is initiated in a first link of a chain, the other links of that chain may also be tested in the same diagnostic test. The diagnostic test may include testing multiple links in a chain synchronously. The diagnostic test may include testing multiple chains synchronously. The diagnostic test may include testing multiple chains simultaneously. In this way, downtime and interruptions to device operation are minimized. One or more links of a chain (e.g., each link in the chain) may be reconfigured from an operating mode to a testing mode, which may involve changing a device port for testing (e.g., by engaging relays or other means of changing over the device port for diagnostic purposes). The results of a test may be sent to and displayed by the hub device. Additionally or alternatively, a signal may be transmitted to an indicator of a device to communicate a result of the test.

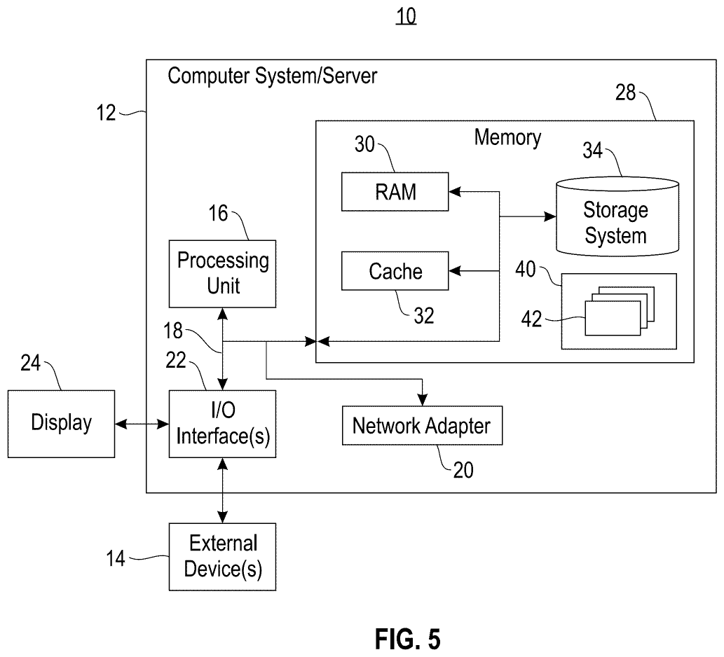

Referring now to FIG. 5, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

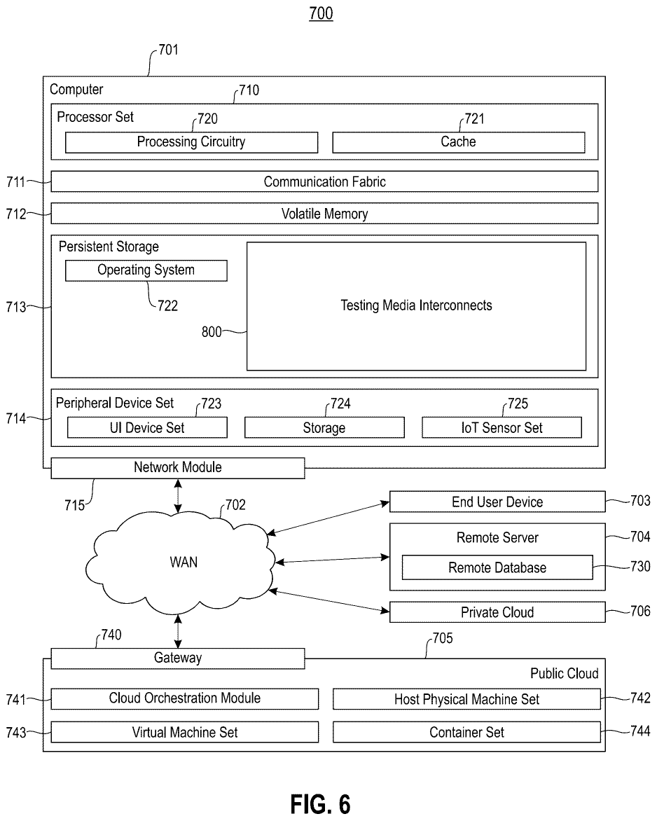

Referring now to FIG. 6, computing environment 700 contains an example of an environment for the execution of at least some of the computer code involved in performing the inventive methods, such as testing media interconnects 800. In addition to block 800, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 800, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 800 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 800 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference has been made in detail herein to the exemplary embodiments of the present disclosure, examples of which are illustrated in the accompanying drawings. The systems, devices, and methods disclosed herein are described in detail by way of examples, and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

For any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

As used herein, the term “about” means a range of values inclusive of the specified value that a person of ordinally skill in the art would reasonably consider to be comparable to the specified value. In some embodiments, “about” means within a standard deviation using measurements generally accepted by a person of ordinary skill in the art. In some embodiments, “about” means ranging up to ±10% of the value. In some embodiments, “about” means ranging up to ±5% of the value. In some embodiments, “about” means the specified value.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of testing media interconnects, the method comprising:
requesting, via a network, a response from a plurality of devices;
requesting, via the network, identification from at least a subset of the plurality of devices;
establishing at least one link within the subset of devices, the at least one link defining a connection between a pair of devices in the subset;
initiating a diagnostic test of one or more linked devices connected by the at least one link;
reading available device sensors of the one or more linked devices; and
based on the available device sensors, determining whether the diagnostic test can be performed without interrupting operation of the one or more linked devices.

2. The method of claim 1, wherein each of the plurality of devices is interconnected via a wireless network.

3. The method of claim 1, further comprising:
reading configuration data of a first device.

4. The method of claim 3, wherein the configuration data include specifications and requirements of the first device.

5. The method of claim 3, wherein the configuration data include an identification of the first device.

6. The method of claim 3, wherein requesting identification from the at least the subset of the plurality of devices is based on the configuration data.

7. The method of claim 3, wherein the first device is directly connected to at least one of the devices in the plurality.

8. The method of claim 1, wherein the plurality of devices includes a microphone, a preamplifier, a mixer, a recorder, and/or an outboard effects unit.

9. The method of claim 1, further comprising:
establishing at least one chain, wherein each chain includes at least two links.

10. The method of claim 9, further comprising:
running the diagnostic test, wherein running the diagnostic test includes synchronously testing one or more links in the at least one chain.

11. The method of claim 9, wherein the at least two links include a first link between a first device and a second device and a second link between the second device and a third device.

12. The method of claim 9, further comprising:
reconfiguring each of the links within a chain for the diagnostic test.

13. The method of claim 12, wherein reconfiguring each of the links within the chain for the diagnostic test includes changing a port.

14. The method of claim 1, further comprising:
sending a status to a hub device.

15. The method of claim 14, wherein the hub device includes a digital audio workstation.

16. The method of claim 1, wherein determining whether the diagnostic test can be performed without interrupting operation of the linked devices includes comparing a probability of interruption to a threshold based on configuration data of a device.

17. The method of claim 16, further comprising:
querying the linked devices; and
determining that the linked devices are eligible for the diagnostic test.

18. The method of claim 1, further comprising:
based on the diagnostic test, transmitting a signal to an indicator of a device.

19. The method of claim 1, further comprising:
detecting that no hub device is established.

20. The method of claim 19, further comprising:
determining that one of the plurality of devices is capable of serving as the hub device; and
broadcasting a message that the one of the plurality of devices is capable of serving as the hub device.

21. The method of claim 19, further comprising:
determining that one of the plurality of devices is a stand-alone device; and
storing a status that the one of the plurality of devices is a stand-alone device.

22. The method of claim 21, further comprising:
sending the status to the hub device when the hub device is established.

23. A computer program product comprising:
one or more computer-readable storage media; and
program instructions stored on the one or more computer-readable storage media to perform operations comprising:
requesting, via a network, a response from a plurality of devices;
requesting, via the network, identification from at least a subset of the plurality of devices;
establishing at least one link within the subset of devices, the at least one link defining a connection between a pair of devices in the subset;
initiating a diagnostic test of one or more linked devices connected by the at least one link;
reading available device sensors of the one or more linked devices; and
based on the available device sensors, determining whether the diagnostic test can be performed without interrupting operation of the one or more linked devices.

24. A computer system comprising:
a processor set;
one or more computer-readable storage media; and
program instructions stored on the one or more computer-readable storage media to cause the processor set to perform operations comprising:
requesting, via a network, a response from a plurality of devices;
requesting, via the network, identification from at least a subset of the plurality of devices;
establishing at least one link within the subset of devices, the at least one link defining a connection between a pair of devices in the subset;
initiating a diagnostic test of one or more linked devices connected by the at least one link;
reading available device sensors of the one or more linked devices; and
based on the available device sensors, determining whether the diagnostic test can be performed without interrupting operation of the one or more linked devices.
